(19) United States
(12) Patent Application Publication
(10) Pub. No.: US 2026/0188600 A1
(43) Pub. Date: Jul. 2, 2026

(54) OMNIDIRECTIONAL REED SWITCH

(71) Applicant: The ADT Security Corporation, Boca Raton, FL (US)

(72) Inventor: Benjamin ADAMS, Bristol, VA (US)

(21) Appl. No.: 19/002,002

(22) Filed: Dec. 26, 2024

(51) Int. Cl. H01H 36/00

(52) U.S. Cl. CPC H01H 36/0033

(57) ABSTRACT

An omnidirectional reed switch including a housing having an inner surface and an outer surface. The omnidirectional reed switch further includes an inner electrically conductive component having one end affixed to a connection point within the housing, the inner electrically conductive component comprising ferromagnetic material, and an outer electrically conductive component located within the housing. The outer electrically conductive component at least partially surrounding the inner electrically conductive component, and one of the inner electrically conductive component and the outer electrically conductive component is movable with respect to the other when the omnidirectional reed switch in the presence of a magnetic field.

### TECHNICAL FIELD

The present technology is generally related to reed switches and more specifically to an omnidirectional reed switch.

### BACKGROUND

Many security systems use sensors to detect motion, such as when a door or window is opened. These sensors include reed switches, which are a special kind of electrical switch that is actuated, i.e., turned on or turned off, by magnetism. The most common type of reed switch features two thin, flexible, ferromagnetic metal blades, or wires, known as “reeds” positioned slightly apart and on the same plane as each other in a sealed glass chamber or enclosure.

However, these types of traditional reed switches have inherent problems. For example, the sensor containing the reed switches must be placed with extreme care because if they are mounted improperly in a manner such that the reeds are not properly oriented with respect to the magnet, the switch will not be activated by the magnetic field from the magnet, and the switch will not operate properly. In these instances, the entire sensor will need to be replaced and remounted in order to be properly positioned with respect to the magnetic field to thereby operate properly.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a front view of an example omnidirectional reed switch according to one embodiment of the present disclosure;

FIG. 2 is a front view of the omnidirectional reed switch of FIG. 1 in the presence of a magnetic field;

FIG. 3 is a front view of another embodiment of the omnidirectional reed switch of the present disclosure;

FIG. 4 is a front view of the omnidirectional reed switch of FIG. 3 in the presence of a magnetic field;

FIG. 5 is a front view of another embodiment of the omnidirectional reed switch of the present disclosure enclosed in an outer enclosure;

FIG. 6 is a front view of another embodiment of the omnidirectional reed switch of the present disclosure without a housing and having a fixed outer conductive component;

FIG. 7 is a front view of the omnidirectional reed switch of FIG. 6 in the presence of a magnetic field;

FIG. 8 is a front view of another embodiment of the omnidirectional reed switch of the present disclosure without a housing and having a fixed inner conductive component;

FIG. 9 is a front view of the omnidirectional reed switch of FIG. 8 in the presence of a magnetic field; and

FIG. 10 is an example premises monitoring system incorporating the omnidirectional reed switch of the present disclosure.

### DETAILED DESCRIPTION

Before describing in detail example embodiments, it is noted that the embodiments reside primarily in combinations of apparatus components and processing steps related to an omnidirectional reed switch. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

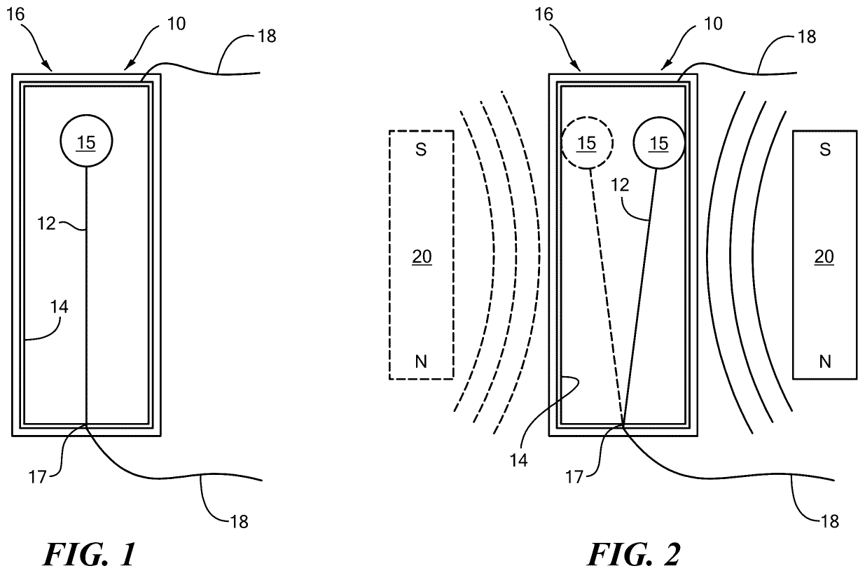

With reference to FIG. 1, there is shown a diagram of an example omnidirectional reed switch 10 in accordance with an embodiment of the present disclosure. In this embodiment, omnidirectional reed switch 10 includes an inner electrically conductive component 12 and an outer electrically conductive component 14. In some embodiments, the inner electrically conductive component 12 includes electrically conductive contact member 15. The inner electrically conductive component 12 and outer electrically conductive component 14 are contained within a housing 16. In one embodiment, inner electrically conductive component 12 may be an elongated ferromagnetic conductive wire, blade, or “reed.” Electrically conductive contact member 15 may also be made of a ferromagnetic conductive material. In some embodiments, electrically conductive contact member 15 is spherical, but it is contemplated that other shapes can be used, e.g., hemisphere, as long as electrically conductive contact member 15 can contact outer electrically conductive component 14 to complete an electrical circuit. One end of inner conductive component 12 is fixed at connection point 17 within housing 16, while the opposing end of inner electrically conductive component 12, i.e., the end that has electrically conductive contact member 15, is movable within the interior of housing 16. Inner electrically conductive component 12 acts as a conduit for a magnetic field such that when an external magnetic field is applied to omnidirectional reed switch 10, inner electrically conductive component 12 and electrically conductive contact member 15, because of their ferromagnetic properties, move within the interior housing 16 in response to the magnetic field. Although FIG. 1 shows inner electrically conductive component 12 being affixed at the bottom of housing 16, in other embodiments it can be affixed at the top of housing 16. In either instance, only one end of inner electrically conductive component 12 is affixed, thus allowing the non-fixed portions to move in response to the magnetic field. In some embodiments, electrically conductive contact member 15 is not used. Electrical leads 18 supply electricity to housing 16 to form an electrical circuit via inner electrically conductive component 12 and outer electrically conductive component 14.

In one embodiment, housing 16 is a glass enclosure. In this embodiment, the inside of the glass tube is coated with a conductive metal, as shown in FIG. 1. Thus, in this embodiment, outer electrically conductive component 14 is actually the conductive metal that is formed along the interior of housing 16. Thus, outer electrically component 14, i.e., the conductive film or layer along the inside surface of housing 16, surrounds or at least partially surrounds inner electrically conductive component 12. The conductive coating on the inside of housing 16 advantageously allows omnidirectional reed switch 10 to be placed virtually anywhere near an external magnet without particular care to what orientation omnidirectional reed switch 10 be placed in relation to the magnet and magnetic field. This is discussed in greater detail below with regards to FIG. 2.

In one embodiment, outer electrically conductive component 14 is formed by applying the conductive material to the inner surface of housing 16 via physical vapor deposition (PVD), which is a process that applies a thin metal film to a non-metallic material in a vacuum chamber.

In one embodiment, the interior of housing 16 is a vacuum. In another embodiment, the interior of housing 16 is filled or at least partially filled with an inert gas such as, for example, Xenon.

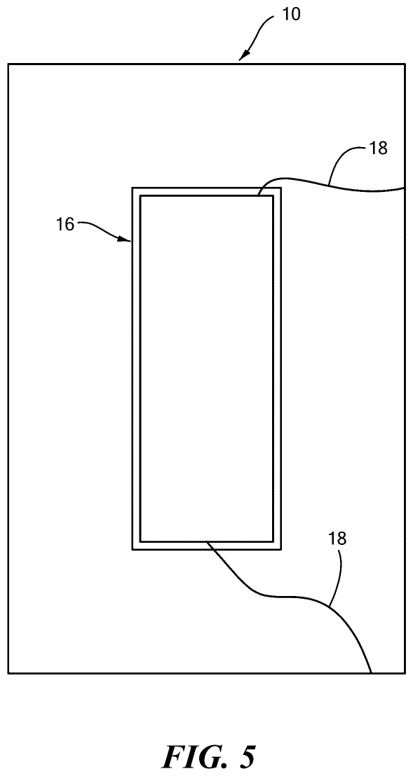

In one embodiment housing 16 is itself housed in an outer enclosure that includes, for example a polymer such as plastic, although the outer enclosure can be made of any material. The outer enclosure is not shown in FIG. 1 or FIG. 2, but is shown in FIG. 5 and discussed below.

Known reed switches utilize two blades near each other and on the same plane or virtually on the same plane, and thus extreme care must be taken to orient the switch in relation to the external magnet, because improper placement of the switch would not move the reed switch blades even in the presence of a strong-enough magnetic field. This prevents the blades from making electrical contact with each other to close the switch. However, in the omnidirectional reed switch 10 of the present disclosure, because outer electrically conductive component 14, i.e., the inner coated surface of housing 16, surrounds or at least partially surrounds the inner electrically conductive component 12 and/or electrically conductive contact member 15, an external magnet can be placed on either side of omnidirectional reed switch 10 provided it is close enough for the magnetic field to be detected. This is because in the presence of a magnetic field, the movable (non-fixed) end of inner electrically conductive component 12 moves due to the magnetic field and need only contact any location of the conductive inner surface of housing 16 (i.e., the outer electrically conductive component 14) in order for electrical contact to be made and omnidirectional reed switch 10 close.

The omnidirectional reed switch 10 shown in FIG. 1 represents a normally open (NO) reed switch. That is, when there is no magnetic field present, inner electrically conductive component 12 does not contact outer electrically conductive component 14, and thus the switch remains open. In the presence of a strong enough magnetic field inner electrically conductive component 12 contacts outer electrically conductive component 14, thus completing the circuit with electrical leads 18, thereby allowing current to flow, as a result of the switch closing. The present disclosure is not limited to NO reed switches. A normally closed (NC) reed switch works in an opposite fashion. When there is no magnetic field, inner electrically conductive component 12 is in electrical contact with outer electrically conductive component 14, and when in the presence of a strong enough magnetic field, inner electrically conductive component 12 separates from outer electrically conductive component 14, thus halting the flow of electricity, resulting in the switch opening. Thus, the present disclosure can be applied to both NO and NC reed switches.

FIG. 2 illustrates the omnidirectional reed switch 10 of FIG. 1 but now proximate an external magnet 20 and its magnetic field. As shown in FIG. 2, the magnetic field is strong enough, i.e., stronger than the biasing force of inner electrically conductive component 12 such that non-fixed portion of inner electrically conductive component 12 is drawn towards the magnetic field and moves within housing 16 until inner electrically conductive component 12 makes contact with the inner conductive coating on the inside of housing 16, i.e., outer electrically conductive component 14, thus closing directional reed switch 10 to complete the circuit. Advantageously, the location of magnet 20 need not be in the position shown in FIG. 2. As long as magnet 20 is close enough to omnidirectional reed switch 10, it can be placed on either side of housing 16 and inner electrically conductive component 12 will move within housing 16 to make electrical contact with outer electrically conductive component 14.

FIG. 2 illustrates how omnidirectional reed switch 10 would still be operational if magnet 20 were placed in a different location such as might occur during an installation of omnidirectional reed switch 10. FIG. 2 shows, in dashed lines, magnet 20 now situated on the opposite side of omnidirectional reed switch 10. In this instance, electrically conductive component 12 moves in the opposite direction as it did in FIG. 1 due to the presence of the magnetic field on the opposite side of omnidirectional reed switch 10. Advantageously, because outer electrically conductive component 14 surrounds or at least partially surrounds movable inner electrically conductive component 12, there is again electrical contact between inner electrically conductive component 12 and outer electrically conductive component 14 but now on the opposite side of outer electrically conductive component 14.

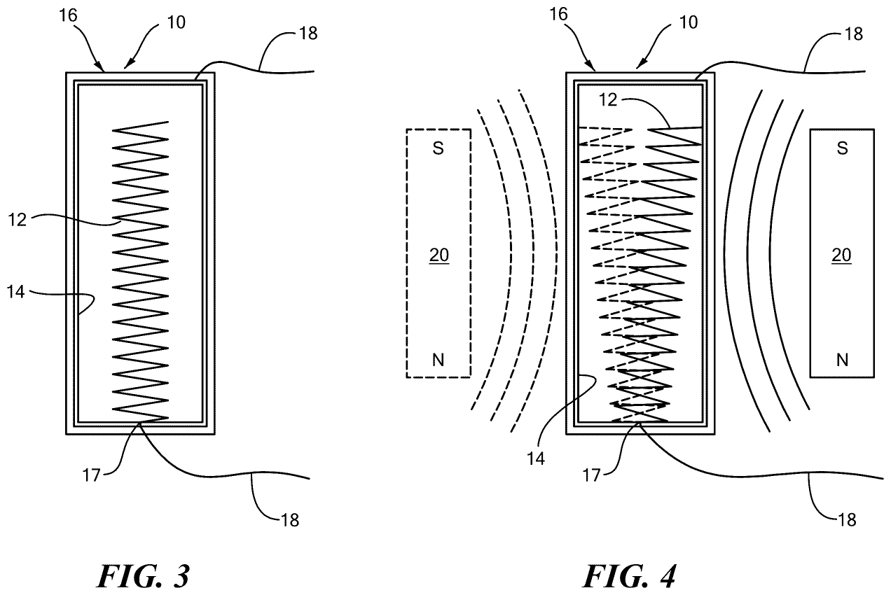

FIG. 3 is an alternate embodiment of omnidirectional reed switch 10. In this embodiment, inner electrically conductive component 12 is in the form of a spring or an otherwise rigidly biased, grid-like structure. As in FIG. 1 and FIG. 2, inner electrically conductive component 12 is fixed at one connection point 17 within housing 16, thereby allowing the non-fixed portion of inner electrically conductive component 12 to move within housing 16 in the presence of a strong-enough magnetic field, in the manner described above and make electrical contact with the conductive coating on the inside surface of housing 16.

FIG. 4 shows the omnidirectional reed switch 10 of FIG. 3 in the presence of magnet 20 and its magnetic field. Here, inner electrically conductive component 12 has been drawn towards the magnetic field resulting in it making electrical contact with outer electrically conductive component 14, i.e., the interior conductive film around the interior of housing 16, thus allowing electricity to flow and omnidirectional reed switch 10 to close. As discussed above, as long as magnet 20 is close enough in proximity to omnidirectional reed switch 10, the non-fixed portion of inner electrically conductive component 12 will move and make contact at some point along the inner conductive portion of housing 16. This provides the freedom of placing magnet 20 adjacent any part of housing 16 that is parallel or substantially parallel, i.e., not orthogonal, to inner electrically conductive component 12 in order for omnidirectional reed switch 10 to properly operate.

FIG. 4, like FIG. 2, illustrates how omnidirectional reed switch 10 would operate if magnet 20 were placed in a different location. FIG. 4 shows, in dashed lines, magnet 20 now situated on the opposite side of omnidirectional reed switch 10. In this instance, electrically conductive component 12 moves in the opposite direction as it did in FIG. 2 due to the presence of the magnetic field on the opposite side of omnidirectional reed switch 10.

Although FIGS. 1-4 show housing 16 as having a rectangular shape, embodiments are not limited to such an arrangement. For example, the views shown in FIGS. 1-4 can be a section view of a housing 16 that is cylindrical along its length. Other geometries are also possible as long as housing 16 is arranged such that inner electrically conductive component 12 can make electrical contact with outer electrically conductive component 14 in the presence of a magnetic biasing field.

FIG. 5 illustrates an alternate embodiment of omnidirectional reed switch 10. In this embodiment, an outer enclosure 22 substantially or fully encloses housing 16 and the components therein (inner electrically conductive component 12 and outer electrically conductive component 14, neither of which are shown in FIG. 5), allowing only electrical leads 18 to protrude through outer enclosure for connection to the rest of the electrical circuit, e.g., a premises monitoring system sensor circuit. Outer enclosure 22, often made of plastic although not limited to any particular material, can be used as an additional layer of protection for omnidirectional reed switch 10. The omnidirectional reed switch 10 shown in FIG. 5 operates in the same fashion as described above.

It should be noted that omnidirectional reed switch 10 can communicate via a wired connection or wirelessly with other components, including a premises monitoring system, which is discussed in further detail below. In other words, electrical leads 18 can be “hard wired” to a controller or other device used to detect switch opening and closing or can be connected to a wireless communication module, e.g., Zigbee, Wi-Fi, cellular, BLUETOOTH, etc., to facilitate wireless communication of the omnidirectional reed switch 10 switch status, e.g., opened or closed, to the controller or other device used to detect switch opening and closing.

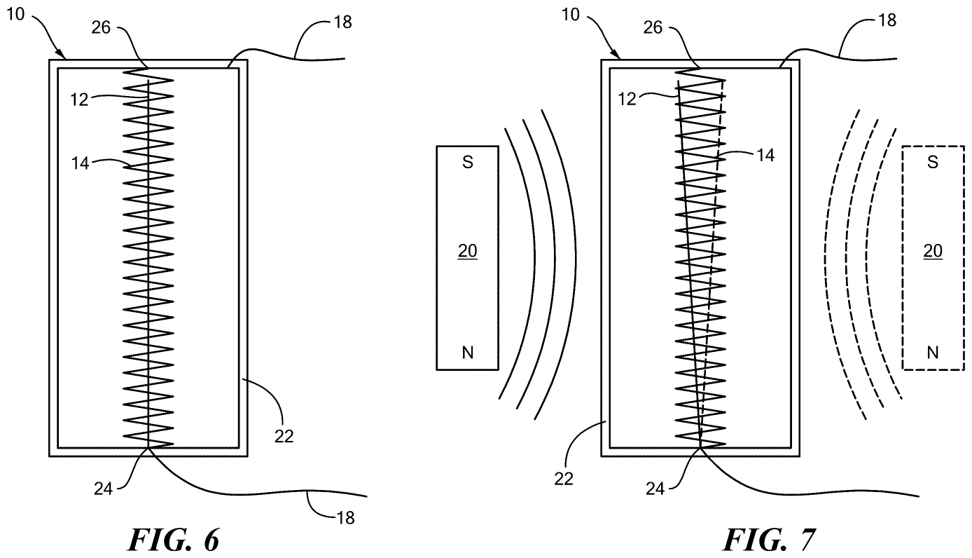

FIG. 6 shows yet another embodiment of omnidirectional reed switch 10. In this embodiment, the housing 16 shown in FIGS. 1-4 is removed. Thus, outer electrically conductive component 14, which in previous embodiments was the conductive coating or film along the interior of housing 16 is now an outer grid-like structure or spring. In this embodiment, inner electrically conductive component 12 is affixed at one end to outer enclosure 22 at first affixation point 24. In other embodiments, inner electrically conductive component 12 is affixed at second affixation point 26. The non-fixed portion of inner electrically conductive component 12 is thus free to move within enclosure 22. In one embodiment, i.e., a NO switch, inner electrically conductive component 12 is positioned within the hollow interior of outer electrically conductive component 14 and is not in electrical contact with any portion of outer electrically conductive component 14. For example, inner electrically conductive component 12 and outer electrically conductive component 14 can be coaxially arranged with respect to one another along their longitudinal axes. Outer electrically conductive component 14 is affixed at its one end to first affixation point 24 of outer enclosure 22. Outer electrically conductive component 14 is also affixed at its top portion at second affixation point 26 as shown in FIG. 6. In this fashion, outer electrically conductive component 14 is affixed at both ends within enclosure 22 and will not move in the presence of a magnetic field. In the embodiment shown in FIG. 6 no magnetic field is present and inner electrically conductive component 12 resides within the hollow interior of outer electrically conductive component 14, e.g., spring, and is not in electrical contact with outer electrically conductive component 14.

FIG. 7 illustrates an embodiment of the omnidirectional reed switch 10 of FIG. 6 but in the presence of magnet 20 and its magnetic field. Because outer electrically conductive component 14 is affixed at both its top and bottom to outer enclosure 22, outer electrically conductive component 14 will not move in the presence of a magnetic field. However, inner electrically conductive component 12, because it is fixed at only one point, e.g., at one end, will move in response to the magnetic field as shown in FIG. 7. In this embodiment, inner electrically conductive component 12 is drawn towards the magnetic field and moves towards magnet 20. In doing so, inner electrically conductive component 12 makes electrical contact with one side of outer electrically conductive component 14, thus allowing current to flow between the components, and from an input electrical lead 18 to an output electrical lead 18, as a result of the closing of omnidirectional reed switch 10. Advantageously, because outer electrically conductive component 14 surrounds or at least partially surrounds inner electrically conductive component 12, magnet 20 can be placed adjacent to any side of omnidirectional reed switch 10 as long as the magnet is not positioned orthogonally to the longitudinal axis of the reed switch 10, and the result will be the same; inner electrically conductive component 12 will be drawn towards the magnet 20 due to its magnetic field and will come into electrical contact with outer electrically conductive component 14 thus allowing current to flow as a result of omnidirectional reed switch 10 transitioning from an open configuration to a closed configuration.

It should also be noted that the placement of magnet 20 in FIG. 7, as well as in preceding figures, is exemplary only. Thus, magnet 20 can be placed along any side of omnidirectional reed switch 10 so long as it is close enough for its magnetic field to be detected. For example, if magnetic 20 were located on the right side of omnidirectional reed switch 10 (as shown by the dashed lines) rather than on its left side as shown in FIG. 7, outer electrically conductive component 14 will remain fixed due to its attachment to the interior of enclosure 22 at first affixation point 24 and second affixation point 26, but inner electrically conductive component 12 will react to the magnetic field by moving towards it, i.e., to the right, as depicted by the dashed line. The result is the same, i.e., the inner electrically conductive component 12, which prior to the introduction of the magnetic field was not in electrical contact with outer electrically conductive component 14 now comes into electrical contact with outer electrically conductive component 14 and omnidirectional reed switch 10 switches from an open to a closed orientation.

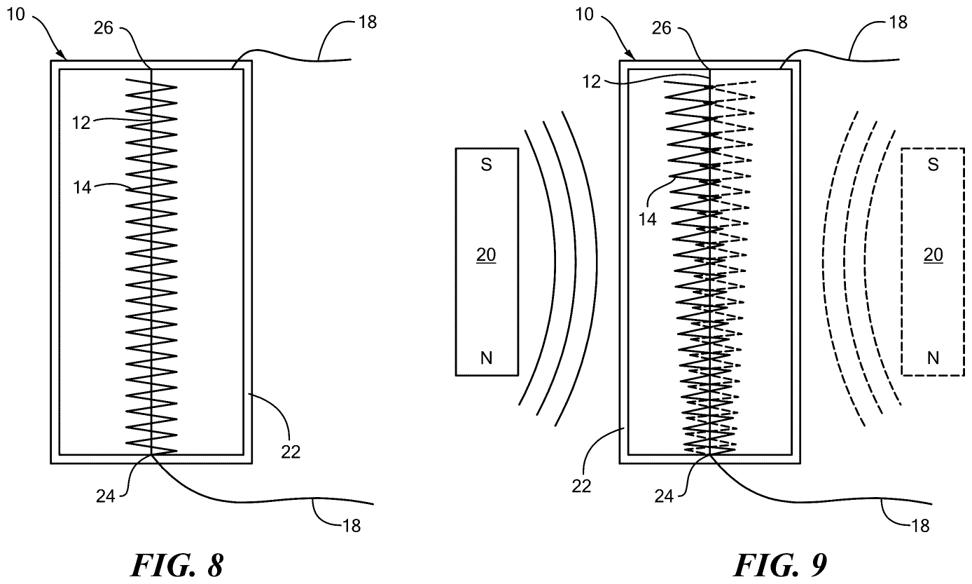

FIG. 8 illustrates another embodiment of the omnidirectional reed switch 10 of the present disclosure. In FIG. 8, inner electrically conductive component 12 is affixed within outer enclosure 22 at both its bottom end, at first affixation point 24, and its top end, at second affixation point 26. Thus, in this embodiment, inner electrically conductive component 12 does not move in the presence of a magnetic field because it is fixed at two points. In this embodiment, outer electrically conductive component 14 is affixed only at first affixation point 24 thus allowing the remaining portion of spring, i.e., outer electrically conductive component 14 to move within enclosure 22 in the presence of a magnetic field. In other embodiments, outer electrically conductive component 14 is affixed only at second affixation point 26. Of note, outer electrically conductive component 14 surrounds or at least partially surrounds inner electrically conductive component 12 as in FIGS. 6 and 7. In FIG. 7, there is no magnetic field and thus inner electrically conductive component 12 remains in the interior of outer electrically conductive component 14 without making contact with it, and thus omnidirectional reed switch 10 is in an open orientation.

FIG. 9 shows the omnidirectional reed switch 10 of FIG. 8 but now in the presence of magnet 20 and its magnetic field. Because of the presence of a magnetic field, the non-fixed portion of outer electrically conductive component 14 moves within enclosure 22. Inner electrically conductive component 12, which, in this embodiment, is affixed at both its top and bottom ends does not move. Outer electrically conductive component 14 moves until it makes contact with inner electrically conductive component 12, allowing electricity to flow between components, closing omnidirectional reed switch 10. Again, the positioning of magnet 20 in FIG. 9 is exemplary only and thus magnet 20 can be situated on either side of omnidirectional reed switch 10 (as shown by the dashed lines) and the result would be the same: outer electrically conductive component 14, affixed at only one end, moves due to the presence of the magnetic field and moves towards it, thus making electrical contact with fixed inner electrically conductive component 12.

Although FIGS. 6-9 show the inner electrically conductive component 12 and outer electrically conductive component 14 affixed to the top and bottom of outer enclosure 22, in other embodiments, the two electrically conductive components can be affixed to opposite sides of outer enclosure 22. In this embodiment, the relationship between the two electrically conductive components is the same, i.e., outer electrically conductive component 14 surrounds or at least partially surrounds inner electrically conductive component 12 and one of the electrically conductive components is fixed at two points within outer enclosure 22 so that it does not move in the presence of a magnetic field, while the other of the two electrically conductive components is affixed at only one point within outer enclosure 22, thus enabling it to move with respect to the other conductive component in the presence of a magnetic field.

In one embodiment, the interior of outer enclosure 22 is a vacuum and in other embodiments the interior of outer enclosure 22 is filed with an inert gas such as, for example. Xenon.

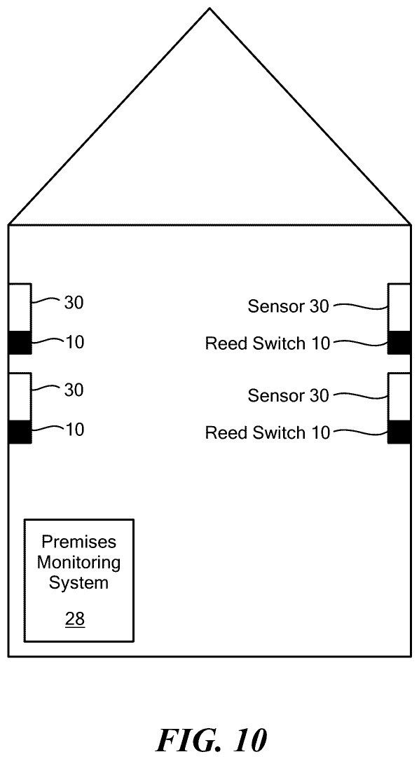

FIG. 10 shows an example premises monitoring system 28, where one or more omnidirectional reed switches 10 are included in sensors 30 that are part of the premises monitoring system 28. Premises monitoring system 28 can comprise one or more premises devices. According to various embodiments, the premises monitoring system 28 may be, for example, a burglary alarm system, an alarm system for monitoring the safety of life and/or property, a home automation system, and/or other types of systems for premises monitoring.

The premises devices may include sensors 30 that include one or more omnidirectional reed switches 10 of the present disclosure for monitoring a premises, image capture devices, audio capture devices, life safety devices, premises automation devices, and/or other devices. For example, the types of sensors may include various life safety-related sensors, such as motion sensors, fire sensors, carbon monoxide sensors, flooding sensors, contact sensors, and other sensor types. Image capture devices may include still cameras and/or video cameras, among other image capture devices. Premises automation devices may include lighting devices, climate control devices, and other types of devices. The premises devices may be configured for sensing one or more aspects of premises, such as an open or closed door, open or closed window, motion, heat, smoke, gas, sounds, images, people, animals, objects, etc.

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings without departing from the scope and spirit of the present disclosure.

What is claimed is:

1. An omnidirectional reed switch comprising:
a housing comprising an inner surface and an outer surface;
an inner electrically conductive component having one end affixed to a connection point within the housing, the inner electrically conductive component comprising ferromagnetic material; and
an outer electrically conductive component located within the housing, the outer electrically conductive component at least partially surrounding the inner electrically conductive component, one of the inner electrically conductive component and the outer electrically conductive component movable with respect to the other when the omnidirectional reed switch is in the presence of a magnetic field.

2. The omnidirectional reed switch of claim 1, wherein the outer electrically conductive component comprises the interior surface of the housing coated with a conductive material.

3. The omnidirectional reed switch of claim 1, wherein the housing is a glass enclosure.

4. The omnidirectional reed switch of claim 1, wherein the housing interior is a vacuum.

5. The omnidirectional reed switch of claim 1, wherein the housing interior is at least partially filled with an inert gas.

6. The omnidirectional reed switch of claim 1, further comprising an outer enclosure, the outer enclosure surrounding the housing.

7. The omnidirectional reed switch of claim 1, wherein the omnidirectional reed switch is included in a sensor that is part of a premises monitoring system.

8. The omnidirectional reed switch of claim 1, wherein when there is no magnetic field present, the inner electrically conductive component is not in electrical contact with the outer electrically conductive component and the omnidirectional reed switch is in a Normally Open (NO) configuration.

9. The omnidirectional reed switch of claim 1, wherein when there is no magnetic field present, the inner electrically conductive component is in electrical contact with the outer electrically conductive component and the omnidirectional reed switch is in a Normally Closed (NC) configuration.

10. An omnidirectional reed switch comprising:
an elongate inner electrically conductive component comprising ferromagnetic material; and
an elongate outer electrically conductive component comprising ferromagnetic material, the outer electrically conductive component at least partially surrounding the inner electrically conductive component, one of the inner electrically conductive component and the outer electrically conductive component movable with respect to the other in the presence of a magnetic field.

11. The omnidirectional reed switch of claim 10, further comprising an outer enclosure having an interior, wherein the outer electrically conductive component is affixed to the interior of the outer enclosure at a first affixation point and at a second affixation point, and the inner electrically conductive component is affixed to the interior of the outer enclosure at one of the first affixation point and the second affixation point, the inner electrically conductive component movable with respect to the outer electrically conductive component in the presence of the magnetic field.

12. The omnidirectional reed switch of claim 10, wherein the inner electrically conductive component is affixed to the interior of the outer enclosure at a first affixation point and at a second affixation point, and the outer electrically conductive component is affixed to the interior of the outer enclosure at one of the first affixation point and the second affixation point, the outer electrically conductive component movable with respect to the inner electrically conductive component in the presence of the magnetic field.

13. The omnidirectional reed switch of claim 10, wherein the outer enclosure comprises a polymer.

14. The omnidirectional reed switch of claim 10, wherein an interior of the outer enclosure is a vacuum.

15. The omnidirectional reed switch of claim 10, wherein the housing interior is at least partially filled with an inert gas.

16. The omnidirectional reed switch of claim 10, wherein the outer electrically conductive component is a grid like structure having a hollow interior, the inner conductive component being positioned at least partially within the hollow interior.

17. The omnidirectional reed switch of claim 10, wherein the omnidirectional reed switch is included in a sensor that is part of a premises monitoring system.

18. The omnidirectional reed switch of claim 10, wherein when there is no magnetic field present, the inner electrically conductive component is not in electrical contact with the outer electrically conductive component and the omnidirectional reed switch is in a Normally Open (NO) configuration.

19. The omnidirectional reed switch of claim 10, wherein when there is no magnetic field present, the inner electrically conductive component is in electrical contact with the outer electrically conductive component and the omnidirectional reed switch is in a Normally Closed (NC) configuration.

20. An omnidirectional reed switch comprising:
a glass housing comprising an inner surface and an outer surface, the inner surface coated with an electrically conductive material;
an elongate inner electrically conductive component having one end affixed to a connection point within the housing, the inner electrically conductive component comprising ferromagnetic material and enclosed by the housing; and
an outer electrically conductive component, the outer electrically conductive component comprising the coated inner surface of the housing, the elongate inner electrically conductive component movable with respect to the outer electrically conductive component when the omnidirectional reed switch is in the presence of a magnetic field.
